(19) United States
(12) Patent Application Publication
(10) Pub. No.: US 2010/0291976 A1
(43) Pub. Date: Nov. 18, 2010

(54) METHOD AND APPARATUS FOR POWER CONSERVATION FOR AN ELECTRONIC DEVICE

(75) Inventors: John Wu, San Diego, CA (US); Thanh Ong, San Diego, CA (US); Todd Conklin, San Diego, CA (US); Brad Kim, San Diego, CA (US); Gwan Hee You, San Diego, CA (US)

Correspondence Address: FOLEY & LARDNER LLP, P.O. BOX 80278, SAN DIEGO, CA, 92138-0278, US

(73) Assignee: Novatel Wireless

(21) Appl. No.: 12/645,388

(22) Filed: Dec. 22, 2009

Related U.S. Application Data
(60) Provisional application No. 61/178,926, filed on May 15, 2009.
(60) Provisional application No. 61/181,645, filed on May 27, 2009.

(51) Int. Cl. G06F 1/32; H04W 4/12; H04B 1/38

(52) U.S. Cl. 455/574; 713/323; 455/466

(57) ABSTRACT

An apparatus comprises a first interface module configured to wirelessly interface with one or more user devices; a second interface module configured to interface with a wireless communication network; and a controller. The controller is configured to detect a signal received through the second interface module, the signal including a command; and execute the command. Executing the command causes one or more components of the apparatus to exit a power conservation mode and enter a full operation mode.

### CROSS-REFERENCE TO RELATED PATENT APPLICATIONS

This application claims priority under 35 U.S.C. §119(e) to U.S. Provisional Patent Application Ser. No. 61/178,926, titled RULE BASED INTERNET BROWSER REDIRECT FOR WIRELESS WWAN ROUTERS, filed May 15, 2009, and U.S. Provisional Patent Application Ser. No. 61/181,645, titled WIRELESS COMMUNICATION SYSTEMS AND METHODS, filed May 27, 2009, each of which is hereby incorporated by reference in its entirety for all purposes.

### BACKGROUND OF THE INVENTION

The present invention relates generally to the field of wireless communication and, more particularly to power conservation for an electronic device.

### SUMMARY OF THE INVENTION

One aspect of the present invention relates to an apparatus comprising a first interface module configured to wirelessly interface with one or more user devices; a second interface module configured to interface with a wireless communication network; and a controller. The controller is configured to detect a signal received through the second interface module, the signal including a command; and execute the command. Executing the command causes one or more components of the apparatus to exit a power conservation mode and enter a full operation mode.

In one embodiment, executing the command causes at least the first interface module to exit a power conservation mode and enter a full operation mode.

In one embodiment, the first interface module includes a WiFi interface. The second interface module may include a 3G network interface.

In one embodiment, the signal received through the second interface module is a short messaging service (SMS) message. In another embodiment, the signal received through the second interface module is a mobile call.

In one embodiment, the controller is further configured to determine a period of inactivity; and place one or more components of the apparatus in a power conservation mode. The controller may determine a period of inactivity based on detection of no user devices connected to the first interface module for a threshold length of time. In another embodiment, the controller determines a period of inactivity based on detection of no traffic between user devices connected to the first interface module and the apparatus for a threshold length of time.

In another aspect of the invention, a method comprises detecting a signal received through one interface module of two or more interface modules of an apparatus, the signal including a command; and executing the command. Executing the command causes one or more components of the apparatus to exit a power conservation mode and enter a full operation mode.

In another aspect, the invention relates to an apparatus comprising a processor and a memory unit coupled to the processor. The memory unit includes computer code for detecting a signal received through one interface module of two or more interface modules of an apparatus, the signal including a command; and computer code for executing the command. Executing the command causes one or more components of the apparatus to exit a power conservation mode and enter a full operation mode.

### BRIEF DESCRIPTION OF THE DRAWINGS

FIG. 1 is a schematic illustration of an arrangement according to an embodiment of the present invention;

FIG. 2 is a schematic illustration of a hotspot device in accordance with embodiments of the present invention; and

FIG. 3 is a flow chart illustrating a method for power conservation in accordance with an embodiment of the present invention.

### DETAILED DESCRIPTION OF THE PREFERRED EMBODIMENTS

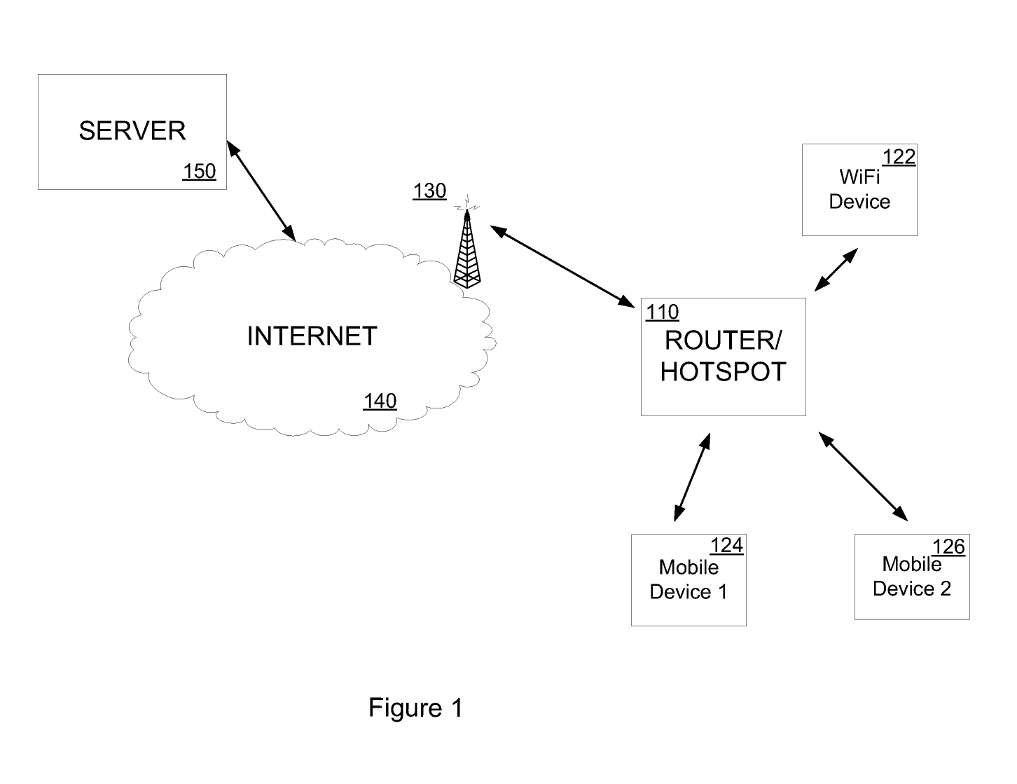

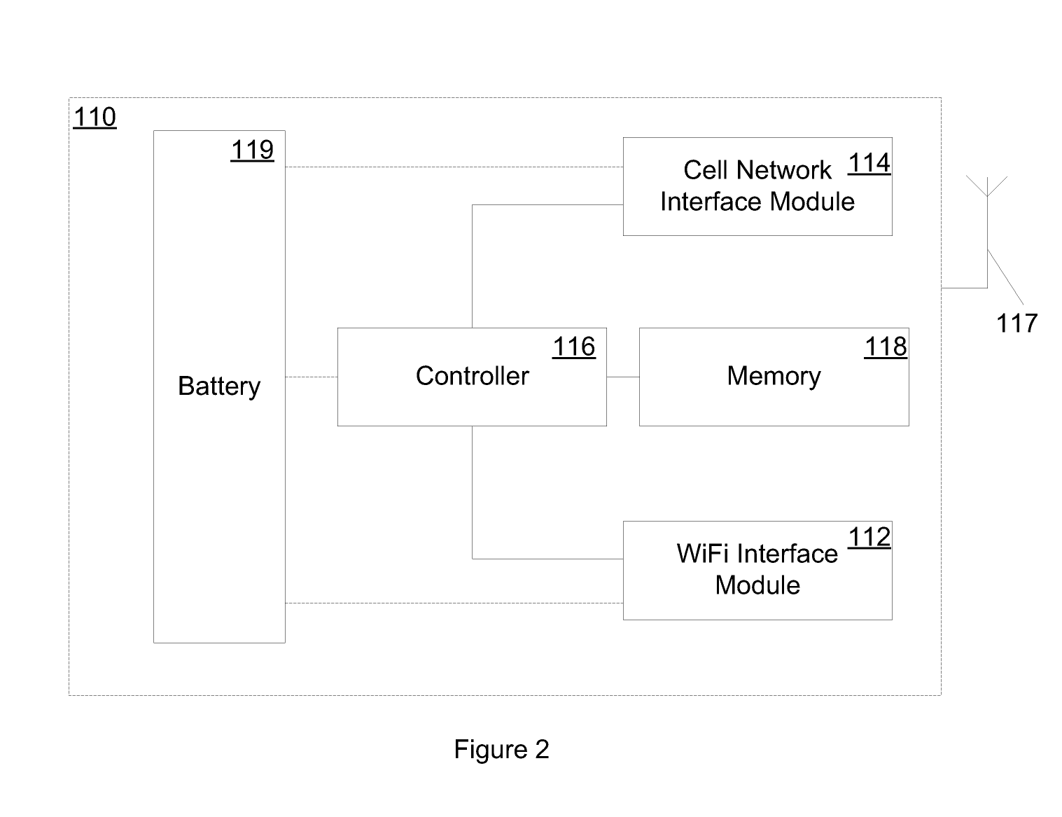

Referring to FIG. 1, an arrangement in accordance with embodiments of the present invention is schematically illustrated. In the illustrated arrangement, a router or hotspot device 110 is provided to allow network access to one or more user devices 122, 124, 126. The user devices 122, 124, 126 may include, for example, a laptop, desktop, portable phone, personal digital assistant (PDA), smart phone or any other device capable of wireless communication. In accordance with embodiments of the present invention, the router 110 is a wireless, mobile, portable hotspot device. One embodiment of the router 110 is described in further detail below with reference to FIG. 2.

The router 110 may be configured to support a variety of user devices. For example, as illustrated in FIG. 1, the router 110 may be accessed by multiple mobile user devices 124, 126, which may be laptops. In addition, WiFi devices, such as a webcam, may also access the router 110. The number of devices which can be supported by the router 110 may vary and may be determined by software, firmware or the like within the router 110.

The router 110 is configured to communicate with a service provider through, for example, a cellular base station 130, through which it may access a communication network 140, such as the Internet. Any of a number of servers (e.g., server 150) may be accessed by the user device through the route 110 and the communication network 140.

Referring now to FIG. 2, an embodiment of the router 110 in accordance with embodiments of the present invention is schematically illustrated. In one embodiment, the router 110 is a wireless wide area network (WWAN)/WiFi data modem personal router which allows multiple users to connect to a network (e.g., 3G network) over WiFi. The router 110 includes a first interface module and a second interface module. In one embodiment, the first interface module is a WiFi interface module 112 configured to allow the router 110 to wirelessly communicate with user devices using, for example, an IEEE 802.11 protocol. Of course, those skilled in the art will understand that other communication protocols may be used to interface with user devices.

The second interface module 114 allows the router 110 to wirelessly interface with a network through, for example, a service provider, as illustrated by the base station 130 of FIG. 1. In accordance with an embodiment of the present invention, the second interface module 114 allows the router 110 to communicate with a cellular network to obtain access to the Internet. Again, those skilled in the art will understand that any of a variety of communication protocols may be used for communication through the second interface module.

The router 110 is also provided with a controller 116, or a processor, configured to control various operations of the router 110. The controller 116 is coupled to the first and second interface modules 112, 114. Further, the controller 116 may be configured to process signals received through the interface modules 112, 114 and to transmit signals through the interface modules 112, 114. A memory unit 118 is provided to store, for example, data or computer code which may be accessed by the controller 116. The router 110 may also include one or more antenna 117 to receive and transmit electronic signals, for example.

Further, the router 110 includes a power source to supply power to the various components of the router 110. Since the router 110 is a portable electronic device, the power source may be a battery 119. In various embodiments, the battery 119 is a rechargeable battery such as a NiCd, Lithium-Ion or other type of rechargeable battery. Of course, the router 110 may include various other components necessary for operation of the router.

As the router is being used by the various user devices, there may be periods of inactivity when the user devices do not require access to, for example, the internet or other user devices. During such periods of inactivity, the router 110 may continue to operate and await signals from the user devices. In this regard, the interface modules 112, 114 and any associated components may continue to operate and consume battery power. In order to conserve battery life, embodiments of the present invention provide for handling of periods of inactivity by reducing operation of the device during such periods.

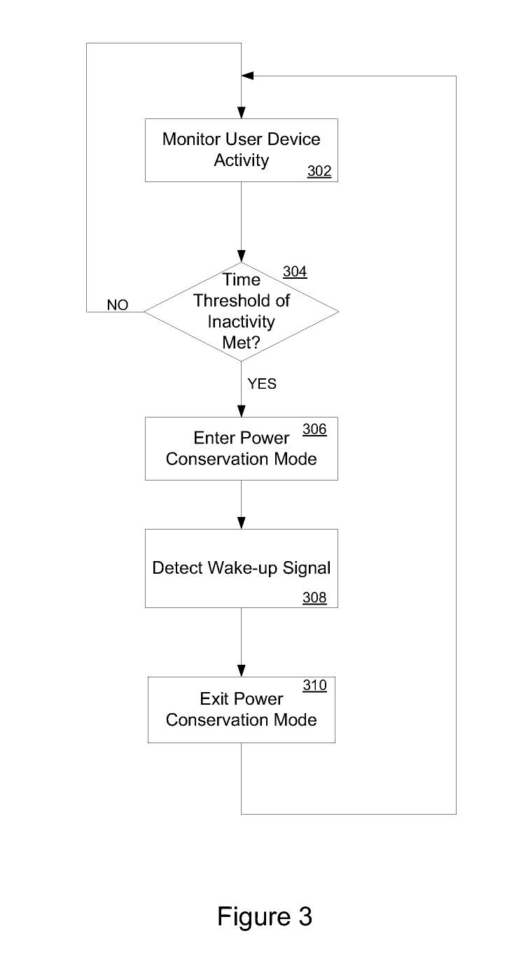

FIG. 3 is a flow chart illustrating a method for power conservation in accordance with an embodiment of the present invention. In accordance with the illustrated method, activity associated with various user devices is monitored (block 302). In this regard, the controller 116 or another component (e.g., firmware or software) of the router 110 may monitor any connected devices. The monitoring may include determining whether any user devices are connected to the router 110. In certain embodiments, the monitoring may include detection of traffic between the connected user devices and the router 110. In this regard, Internet Protocol (IP) traffic and WiFi traffic may be monitored separately.

Monitoring of the user device activity at block 302 may be used to detect or determine periods of inactivity. Thus, at block 304, a determination is made as to whether a threshold of inactivity has been met. In this regard, a period of inactivity may be defined if the monitoring of user device activity detects lack of such activity for a certain period of time. The time threshold required to declare a period of inactivity may be fixed within firmware or may be made variable. In one embodiment, the time threshold may be based on input by a user or administrator of the router 110. In another embodiment, the time threshold may be varied based on detected battery levels. In this regard, as remaining battery power decreases, the time threshold may be reduced in order to conserve more battery power.

Further, in making the determination at block 304, inactivity may be determined if no user devices are detected as connected to the router 110. If no user devices are detected as connected for the length of time set as the threshold, a period of inactivity may be declared. In other embodiments, at block 304, inactivity may be determined even when connected user devices are detected. In this case, inactivity may be determined based on the lack of traffic between the connected user devices and the router 110. The lack of traffic may be lack of IP traffic, lack of WiFi traffic or both.

If the determination is made at block 304 that the time threshold of inactivity has not been met, the router 110 stays in operational mode and continues to monitor user device activity at block 302. On the other hand, if the determination is made at block 304 that the time threshold of inactivity has been met (e.g., period of inactivity is declared), the method proceeds to block 306.

At block 306, the router 110 enters a power conservation mode. In the power conservation mode, certain components of the router 110 may be turned off or placed into a low-power state. In one embodiment, the WiFi interface module 114 and/or other components may be turned off. Further, the controller and/or other components may be placed in a low-power state or sleep state. The low-power state or sleep state may be defined by a reduced operation level of the components resulting in reduced power consumption.

In one embodiment, the components that are turned off or placed in a low-power mode may be determined by the basis for the period of inactivity. For example, if a period of inactivity was determined at step 304 based on a lack of user devices connected to the router 110, the power conservation mode may include placing the entire device in a low-power mode. Alternatively, if one or more user devices are connected, but a period of inactivity is determined based on a lack of traffic between the user devices and the router 110, the power conservation mode may include only placing the WiFi interface module 114 in a low-power mode.

In certain implementations of the router 110, a wake-up button may be provided on the body of the router 110. When a user wishes to access the capabilities of the router 110, the button is pressed by the user, and the router 110 is placed in a full operational mode. In accordance with certain embodiments of the present invention, the router 110 may be configured to exit the power conservation mode even if the user cannot physically reach the router 110. In this regard, the router 110 (or the controller 116 of the router 110) may be configured to detect an incoming wake-up signal, as indicated in block 308 of FIG. 3. The ability to detect the wake-up signal may be implemented as software or firmware. In various embodiments, the router is configured to detect an over-the-air channel, such as wireless wide area network (WWAN) channel for such a signal.

The wake-up signal may be in the form of a mobile call or a short messaging service (SMS) message received by the router 110. In this regard, the wake-up signal may be received through a 3G network interface module, such as the second interface module 114 of the router. The wake-up signal may be sent by the user using either the same device as the device desiring access to the router 110 or a different device. For example, if the user desires access to the router 110 for a laptop computer, the user may send a mobile call or an SMS message from a separate mobile phone to wake up the router 110. Alternatively, if the user desires access to the router 110 for a smart phone, the same smart phone may be used to send the mobile call or the SMS message.

In various embodiments, the mobile call or the SMS message may include any of a variety of commands. As described above, in one embodiment, the mobile call or SMS message may command the router 110 to exit the power conservation mode and enter a full operational mode. Thus, in accordance with embodiments of the present invention, while the router 110 is in a power conservation mode with one or more components in a low-power mode or turned off, a wake-up signal may be detected to place the device in a full operational mode. Thus, while the WiFi interface module is turned off, a mobile call or an SMS message may be received through a 3G network interface module

In other embodiments, the mobile call or SMS message may be configured to adjust security settings of the router 110. For example, an administrator of the router 110 may select from a set of preconfigured security profiles of the router 110 by sending a mobile call or an SMS message. In other embodiments, the administrator may use the mobile call or SMS message to lock or shut down the router 110. Thus, whether the router 110 is in a power conservation mode or in a full operational mode, the administrator may use any mobile device to send commands to the router 110 through a 3G network, for example.

Various embodiments of the present invention may be implemented in a system having multiple communication devices that can communicate through one or more networks. The system may comprise any combination of wired or wireless networks such as a mobile telephone network, a wireless Local Area Network (LAN), a Bluetooth personal area network, an Ethernet LAN, a wide area network, the Internet, etc.

Communication devices may include a mobile telephone, a personal digital assistant (PDA), a notebook computer, etc. The communication devices may be located in a mode of transportation such as an automobile.

The communication devices may communicate using various transmission technologies such as Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

An electronic device in accordance with embodiments of the present invention may include a display, a keypad for input, a microphone, an ear-piece, a battery, and an antenna. The device may further include radio interface circuitry, codec circuitry, a controller and a memory.

Various embodiments described herein are described in the general context of method steps or processes, which may be implemented in one embodiment by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various embodiments of the present invention can be accomplished with standard programming techniques with rule-based logic and other logic to accomplish various database searching steps or processes, correlation steps or processes, comparison steps or processes and decision steps or processes.

The foregoing description of various embodiments have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. An apparatus, comprising:
a first interface module configured to wirelessly interface with one or more user devices;
a second interface module configured to interface with a wireless communication network; and
a controller configured to:
detect a signal received through the second interface module, the signal including a command; and
execute the command,
wherein executing the command causes one or more components of the apparatus to exit a power conservation mode and enter a full operation mode.

2. The apparatus of claim 1, wherein executing the command causes at least the first interface module to exit a power conservation mode and enter a full operation mode.

3. The apparatus of claim 1, wherein the first interface module includes a WiFi interface.

4. The apparatus of claim 1, wherein the second interface module includes a 3G network interface.

5. The apparatus of claim 1, wherein the signal received through the second interface module is a short messaging service (SMS) message.

6. The apparatus of claim 1, wherein the signal received through the second interface module is a mobile call.

7. The apparatus of claim 1, wherein the controller is further configured to:
determine a period of inactivity; and
place one or more components of the apparatus in a power conservation mode.

8. The apparatus of claim 7, wherein the controller determines a period of inactivity based on detection of no user devices connected to the first interface module for a threshold length of time.

9. The apparatus of claim 7, wherein the controller determines a period of inactivity based on detection of no traffic between user devices connected to the first interface module and the apparatus for a threshold length of time.

10. A method, comprising:
detecting a signal received through one interface module of two or more interface modules of an apparatus, the signal including a command; and
executing the command,
wherein executing the command causes one or more components of the apparatus to exit a power conservation mode and enter a full operation mode.

11. The method of claim 10, wherein executing the command causes at least one other of the two or more interface modules to exit a power conservation mode and enter a full operation mode.

12. The method of claim 10, wherein the signal is received through a 3G network interface module.

13. The method of claim 10, wherein one of the two or more interface modules includes a WiFi interface.

14. The method of claim 10, wherein the signal received through the second interface module is a short messaging service (SMS) message.

15. The method of claim 10, wherein the signal received through the second interface module is a mobile call.

16. The method of claim 10, further comprising:
determining a period of inactivity; and
placing one or more components of the apparatus in a power conservation mode.

17. The method of claim 16, wherein a period of inactivity is determined based on detection of no user devices connected to a WiFi interface module for a threshold length of time.

18. The method of claim 16, wherein a period of inactivity is determined based on detection of no traffic between user devices connected to a WiFi interface module and the apparatus for a threshold length of time.

19. An apparatus, comprising:
a processor; and
a memory unit coupled to the processor and including:
computer code for detecting a signal received through one interface module of two or more interface modules of an apparatus, the signal including a command; and
computer code for executing the command,
wherein executing the command causes one or more components of the apparatus to exit a power conservation mode and enter a full operation mode.
